(19) United States
(12) Patent Application Publication
(10) Pub. No.: US 2016/0045965 A1
(43) Pub. Date: Feb. 18, 2016

(54) TAP SLEEVE APPARATUS AND METHOD OF USE

(71) Applicants: Kenneth Terpo, Odenville, AL (US); Brian Graaf, Oxford, AL (US)

(72) Inventors: Kenneth Terpo, Odenville, AL (US); Brian Graaf, Oxford, AL (US)

(73) Assignee: HONDA MOTOR CO., LTD., Tokyo (JP)

(21) Appl. No.: 14/459,629

(22) Filed: Aug. 14, 2014

(51) Int. Cl. B23G 1/46; B23G 1/26

(52) U.S. Cl. CPC B23G 1/46; B23G 1/265

(57) ABSTRACT

A tap sleeve for accepting one of a variety of different tap tools for use to repair thread damage to an item being assembled on an assembly line. The tap sleeve is configured with a handle portion configured to be held by the worker, and a base portion for securing the tap tool and limiting the depth in which the tap tool can be inserted, while avoiding damaging the surface of the item being worked and while preventing the hand of the user from slipping toward the tap tool. Optionally, a removable head can be used to adapt the tap sleeve for use with another tool, such as a wrench, to provide additional torque.

### BACKGROUND

Currently, during the assembly of vehicle parts using threaded fasteners mating with matching threaded receptacles, damage to the receptacle threads and/or the fastener threads can occur during assembly, such as by over-tightening or cross-threading.

In such circumstances as cross threading or other damage to the threads that may occur during the assembly process, workers have conventionally use a thread tap tool to correct the damage to the threads of the receptacle to allow the assembly operation to be completed, rather than scrapping the part(s) with damaged receptacles. However, in some cases, the tap tool may be over-inserted into the threaded receptacle, potentially further damaging the part. In other cases, workers could contact the sharp tap threads during use of the tap tool, such as by slippage during the tapping process.

### SUMMARY

Provided are a plurality of example embodiments, including, but not limited to, a tap sleeve comprising: a base portion having a receptacle for receiving a tap tool; a handle portion adapted for being held by a hand of a person using the tap sleeve, and having one end connecting to said base portion forming a ridge having a diameter larger than a diameter of the handle portion; and a stop sleeve extending from said base portion receptacle, said stop sleeve being adapted to control a maximum depth of insertion of the tap tool into a receptacle being tapped using the tap sleeve with the tap tool. The tap sleeve is configured to receive any one of a plurality of differently sized tap tools.

Still further provided is an example tap sleeve comprising: a base portion having a receptacle for receiving a tap tool and also having a threaded receptacle for receiving a set screw for securing the tap tool in the receptacle; and a handle portion adapted for being held by a hand of a person using the tap sleeve, and having one end co-axially connecting to said base portion forming a ridge at the point of connection, said ridge having a diameter larger than a diameter of the handle portion, said ridge being configured to help prevent the hand of the person from slipping toward the tap tool. The base portion is configured to control a maximum depth of insertion of the tap tool into a receptacle being tapped using the tap sleeve with the tap tool, and said tap sleeve is configured to receive any one of a plurality of differently sized tap tools.

Also provided is an example tap sleeve as provided above further comprising a head portion connected to another end of the handle portion, said head portion having a threaded receptacle that is configured to receive a removable tool head configured to receive an external tool for providing a rotational torque to the tap sleeve.

Further provided is an example tap sleeve as provided above with the tap sleeve portions being arranged co-axially as an integral device.

Still further provided is a tapping system for repairing a threaded receptacle of a workpiece, the tapping system comprising one of the example tap sleeves with a tap tool properly installed therein.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 shows an example embodiment of an example tapping system including a first example embodiment of a tap sleeve;

FIGS. 2A-2C are various views of an example body portion of a second example embodiment of a tap sleeve;

FIGS. 3A-3C are various views of another example body portion of a third example embodiment of a tap sleeve;

FIG. 4 shows another example body portion of a fourth example embodiment of a tap sleeve;

FIG. 5 shows three different example stop sleeves of different lengths for use with an example tap sleeve;

FIG. 6 shows three different example removable tool heads for use with an example tap sleeve, each for use with a different tool; and

FIG. 7 shows an example workpiece that could be used in an example assembly operation using a tap tool.

### DETAILED DESCRIPTION OF THE EXAMPLE EMBODIMENTS

A tap sleeve is provided that can be used with a variety of different tap tools by a worker to repair damage that may have occurred during an assembly operation of an item being assembled on an assembly line, such as a vehicle, for example. The tap sleeve is configured with a handle portion configured to be held by the worker, and a base portion for receiving and securing the tap tool and limiting the depth in which the tap tool can be inserted, while avoiding damaging the surface of the item being worked and while preventing the hand of the user from slipping toward the tap tool. Optionally, a removable head can be used to adapt the tap sleeve for use with another tool, such as a wrench, to provide additional torque.

The tap tool is used to fix threads in a hole that may have been damaged when originally tapped, or when attempting to insert a fastener when assembling parts in an assembly operation, whether the fastener was being manually inserted, or using an automated process such as using a robot, for example.

The tap sleeve can be configured to accept a plurality of different tap tool sizes so that a single tap sleeve design can be used for many different operations on different parts and/or at different locations on an assembly line, and/or in different industries. The tap sleeve is configured to have a handle portion that will fit comfortably in the hand of the worker, while with a base portion configured in a manner with a raised ridge adapted to help avoid slippage of the hand toward the tap tool to avoid contact of the worker with the sharp tap threads on the tap tool.

Generally, a worker at any given assembly location will typically be working with only one type and one size of fastener, in which case the tap sleeve will be provided (assembled) with a single appropriate size of tap tool for use by that worker to repair damaged receptacles (holes with damaged female threads) at the worker's location. But because the tap sleeve can accept a variety of tap tool sizes, the same type of sleeve can be used at different locations by different workers even when different size taps might be utilized. Should the worker be required to change the tap size, such as during a change of assembly operation at that location, or should the worker need to use tap tools of different sizes at a given assembly location, the worker could either change out the tap tool to a different size of tap tool, or tap sleeves with the desired tap sizes already installed could be provided to the worker. As a tap tool wears out, the worn tap tool can be replaced, as necessary, with a new tap tool in the same tap sleeve.

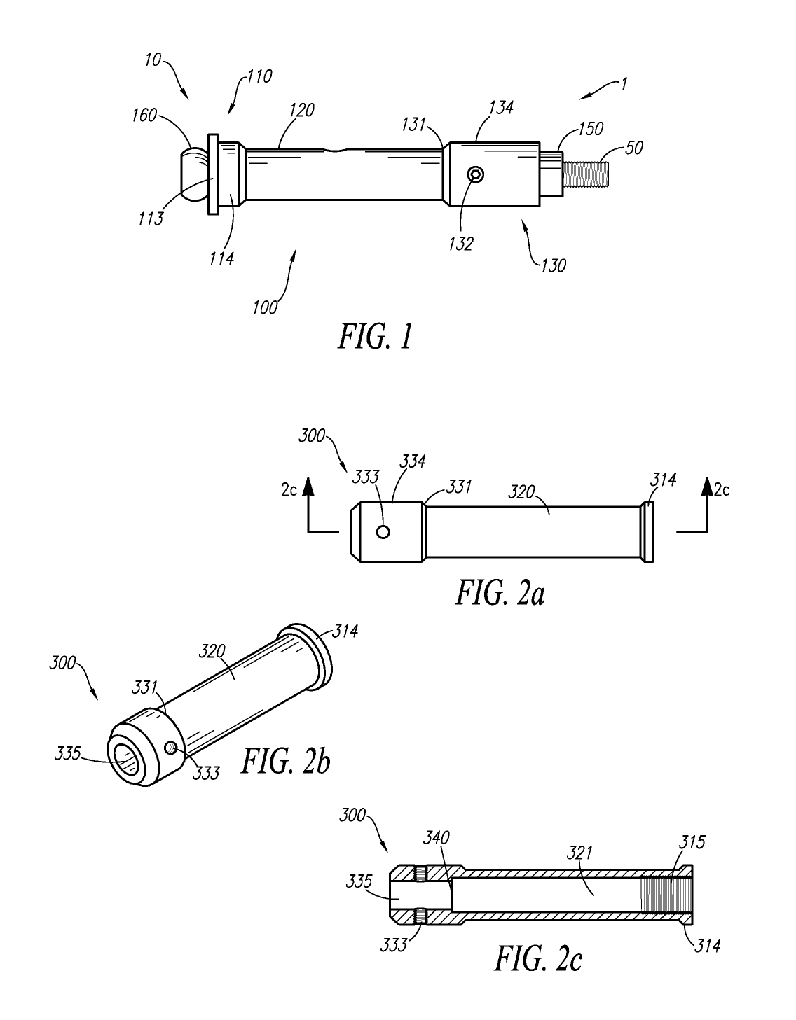

FIG. 1 shows an example tapping system 1 with a tap tool 50 installed in an example tap sleeve 10. The tap sleeve 10 has a body portion 100, including a head portion 110 for receiving a hex tool head 160 connected to a handle head 114, with the hex tool head 160 being adapted to receive a wrench or other tool. The tap sleeve body portion 100 includes a handle portion 120 and a base portion 130 having a base 134 for receiving the tap tool 50 in a receptacle in the base portion 130. A set screw 132 is provided in a receiving hole provided in the base 134 to hold the tap tool 50 in place in a corresponding receptacle of the base 134.

The handle portion 120 is adapted to be held by the hand of a user of the system 1. The base 134 connects to the handle portion 120 forming a hand ridge 131 at the interface that provides a “stop” for the hand of the user. For example, the ridge 131 may have a diameter larger than a diameter of the handle portion 120 to help prevent the hand of the user from sliding down toward the tap tool 50 during the tapping process.

The above described components of the tap sleeve 10 will typically be made of a durable metal, such as steel, aluminum, or some other strong, easily manufactured material. The body portion 100 of the tap sleeve 10 could be made from a uniform block material (e.g., steel) machined to form a single integrated, uniform piece with all of the portions including the head portion 110, the handle portion 120, and the base portion 130. Alternatively, the different portions of the head portion 110, the handle portion 120, and base portion 130 could be individually made of the same, or different, materials, with the portions 110, 120, and 130 being assembled into the completed body portion 100, if desired.

The hex tool head 160 can be made removable and replaceable, so that different sized hex heads can be used to match the available wrench sizes. As one example, body portion 100 including the handle portion 120, the handle head 114, and the base 134 could be machined from a uniform block of material such as steel, with a threaded female receptacle formed co-axially in the handle head 114 for receiving the hex tool head 160 having a matching male thread for installing in the handle head 114 of the body portion 100. In such an embodiment, the hex tool head 160 of one size could be replaced with a hex head of another size to increase the utility of the resulting tap sleeve for use with different sized wrenches, for example.

If the tool head is to be used for rotating the tap tool in both directions, a means of fixing the tool head in place could be provided. For example, a set nut could be provided on the threads of the tool head to set the tool into the handle head 114, or the tool head might be permanently glued, welded, brazed, or soldered into place, for example.

In some embodiments, a commercially available hex bolt could be used as the hex tool head 160, and in some embodiments a washer 113 may be used as shown to ease the removal and replacement of the hex tool head 160. The hex bolt chosen for use with the hex tool head 160 could be the same bolt type that is to be used during the assembly operation for installing the receptacle being repaired, allowing the same tool that is used to install the bolt in the workpiece to be used to tighten and loosen the tap tool. In alternative embodiments, the hex tool head 160 may be replaced with an alternative tool head adapted to receive a hex wrench, a screw driver (flat or Phillips), or adapted to receive some other tool, any of which can be used for aiding in rotating the tap sleeve 10 to provide additional torque to perform a tapping function. Power tools could be utilized, where desired. In such alternatives, the tool head may be replaceable for different sized tools, or it may be made integral to the body portion of the sleeve. In this way, the tap sleeve can be adapted to use tools that would otherwise already be available at the location of use or otherwise easily attainable.

As a further alternative, the handle portion 120 could be coated with, or constructed of, a softer material, such as a rubber or plastic material, or wood, for holding comfort and to facilitate gripping of the handle portion 120 by the hand of the user.

The example tap sleeve 10 is also provided with a replaceable stop sleeve 150 that provides feedback to the user and prevents over-insertion of the tap into a receptacle during use by limiting the depth of insertion of the tap tool during use of the tapping system 1 to some predetermined desired maximum depth. Different sizes (lengths) of stop sleeves 150 could be utilized for different applications of the tap sleeve 10, such that any give tap sleeve can be customized for the particular tap depth needed for a particular application of the tap sleeve system 1. Alternatively, the maximum depth could be set using an adjustable stop sleeve 150, such as one that slides in and out in a variable fashion, and which could be at the desired setting using the set screw 132 or another set screw. The stop sleeve 150 can be made of a relatively soft material, such as a plastic or a rubber material, for example, to avoid damage or scuffing of the part being repaired or its surface once the tap sleeve 10 comes into contact with the part when the tap tool 50 is fully inserted into the receptacle being repaired. Although softer materials may be better suited to avoiding damage to the part, materials that are too soft might lead to over-insertion of the tap into the receptacle in some situations, and hence the material should be strong enough not to allow the tap tool to be over inserted into the receptacle.

In some alternatives, the stop sleeve 150 could be eliminated or made optional by making the base 134 serve the same function by controlling the length of the base 134 and/or by controlling the depth in which the tap tool 50 is inserted into the base 134 so that the base 134 design is used to control the maximum depth of the tap tool during use. To protect the part being repaired, the end of the base 134 might be coated with a relatively soft substance, such as rubber or plastic, for example, or a cap made of these materials may be provided for placing over the end of the base. For this example embodiment, a given tap sleeve design might have a default fixed maximum insertion depth for any given tap tool, or the insertion distance of the tap tool 50 into in the base 134 might be made variable by some other means.

In the example of FIG. 1, the head portion 110, the handle portion 120, and the base portion 130 are provided substantially cylindrical in shape and arranged co-axially, although in alternative embodiments different arrangements and/or shapes could be used (e.g., polygonal). For example, an embodiment not using a tool head could be used with the handle portion arranged cross-wise with the base portion so that the axis of the handle portion is perpendicular to the base portion (forming a “T” shape).

FIG. 2A shows a side view and FIG. 2B shows a perspective view of an example embodiment of a body portion 300 of an example tap sleeve that can be formed of a single block of material such as steel or aluminum. This body portion 300 has a head portion 314, a handle portion 320, and a base portion 334. A hand ridge 331 is formed at the intersection of the handle portion 320 and the base portion 334, and a threaded set hole 333 in the base portion 334 provides a receptacle for receiving a set screw for setting a stop sleeve (not shown) and a selected tap tool (not shown) in place. Tap hole 335, shown in FIGS. 2B and 2C, provides a receptacle to receive the selected stop sleeve and the selected tap tool (not shown).

FIG. 2C shows a cut-away of the body portion 300 cut along line A-A (in FIG. 2A) to show the interior of the body portion 300. Head threads 315 are shown that can receive a tool head (not shown) of the desired type and size. Also provided is a tap stop 340 that stops an inserted tap tool (not shown) at the desired depth. The handle 320 is provided with a hollow portion 321 to reduce the weight of the tap sleeve. The tap stop 340 can be placed in a location at any reasonable point along the length of the hollow portion 321 (avoiding interference with the head threads 315, however) to accommodate the structure of the desired tap tool(s) to be utilized.

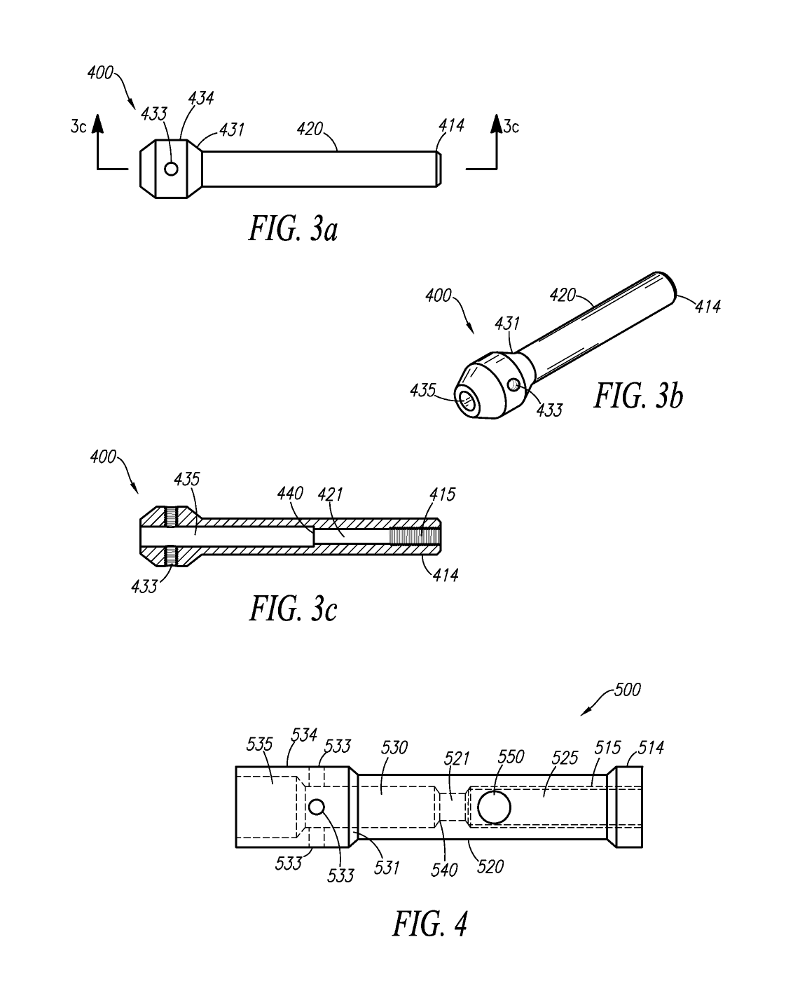

FIG. 3A shows a side view and FIG. 3B shows a perspective view of another example embodiment of a body portion 400 of an example tap sleeve that can be formed of a single block of material such as steel or aluminum. This body portion 400 has a handle portion 420 and a head portion 414 that, in this embodiment, does not have a defined external shape separate from the handle 420. A hand ridge 431 is formed at the intersection of the handle portion 420 and a base portion 434, and a threaded set hole 433 in the base portion 434 provides a receptacle for receiving a set screw for setting the selected stop sleeve (not shown) and the selected tap tool (not shown) in place. Tap hole 435, shown in FIGS. 3B and 3C, provides a receptacle to receive a selected optional stop sleeve (not shown) and the selected tap tool(s) (not shown).

FIG. 3C shows cut-away of the body portion 400 cut along line A-A (in FIG. 3A) to show the interior of the body portion 400. Head threads 415 are shown that can receive a tool head (not shown) of the desired type and size. Also provided is a tap stop 440 that stops an inserted tap tool at a desired depth. The handle 420 is provided with a hollow portion 421 to reduce the weight of the tap sleeve.

FIG. 4 shows another example embodiment of a body portion 500 of an example tap sleeve that can be formed of a single block of material such as steel or aluminum. This example body portion does not utilize a stop sleeve. This body portion 500 has a head portion 514, a handle portion 520, and a base portion 534. A hand ridge 531 is formed at the intersection of the handle portion 520 and the base portion 534. A plurality of threaded set holes 533 (in this case three are shown and a fourth is not shown) are provide to receive corresponding set screws used to ensure that the selected tap tool (not shown) is properly seated in the base portion 534. First tap hole portion 535 provides a first receptacle to receive a first portion of the selected tap tool and second tap hole portion 530 provides a second receptacle to receive a second portion of the selected tap tool.

The body portion 500 of the example tap sleeve also has a head hole 525 with threads 515 that can receive a tool head (not shown) of the desired type and size. A threaded set hole 550 is provided to fix any installed tool head in place. Also provided is a tap stop 540 that stops an inserted tap tool at a desired depth. The handle 520 is provided with a hollow portion 521 to reduce the weight of the tap sleeve.

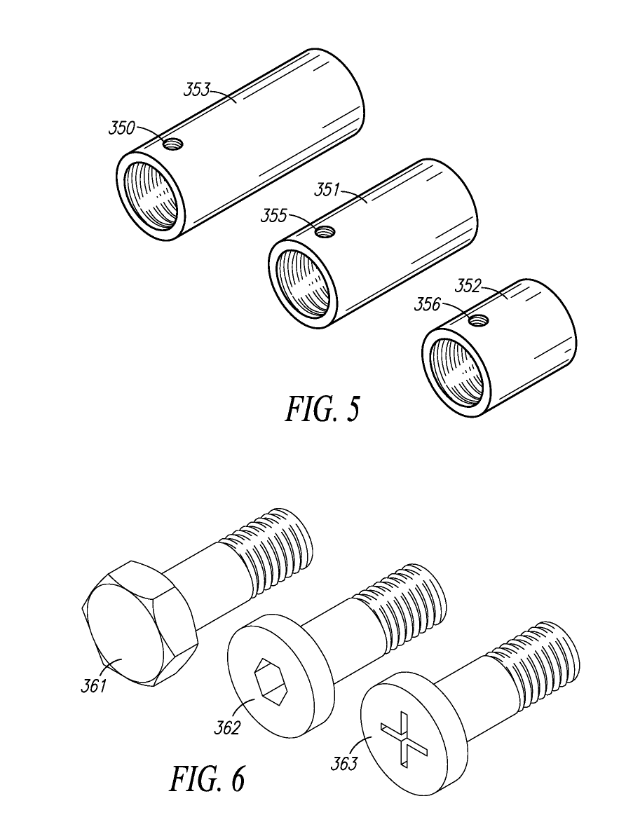

FIG. 5 shows a variety of stop sleeves 351, 352, 353 of different lengths that could be used with the body portion 300 of FIG. 2A-2C or with body portion 400 of FIGS. 3A-3C, for example. Note that these stop sleeves 351, 352, 353 each have corresponding set holes 355, 356, and 357 that will align with the set hole 333 of the body portion 300 or set hole 433 of body portion 400, so that the set screw (not shown) will pass through the holes to contact and thereby set in place any installed tap tool (not shown). An appropriate stop sleeve of the desired length is chosen to achieve the desired tap depth during use of the resulting tapping system. Any number of different stop sleeves lengths could be provided, as desired to achieve the desired different depths for particular applications. The stop sleeves might be made to be a tight fit in the tap hole 335, 435. Also, adjustable stop sleeves might be provided, such as by using a separate set screw and hole pair provided with the base portion, for example.

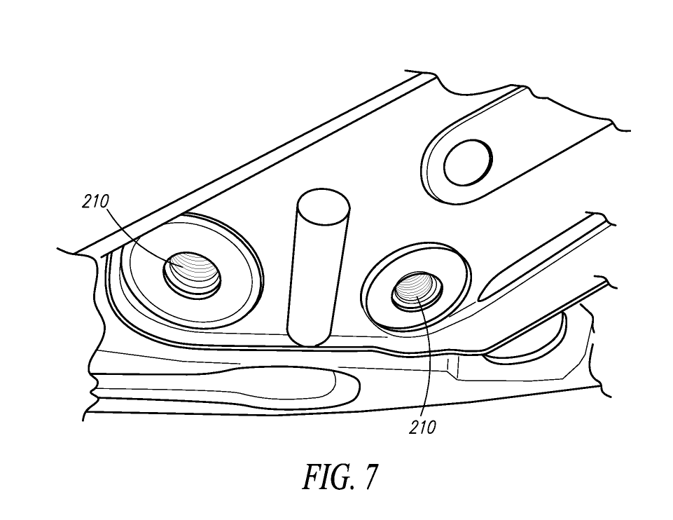

FIG. 6 shows a variety of different example tool heads 361, 362, 363 that can be matched with a head portion of an appropriate tap sleeve. Shown are an example hex tool head 361, an example hex key tool head 362, and an example Philips tool head 365 that can be threaded in the head threads of the head portion of the tap sleeve. Any of these tool heads 361, 362, 363 might be used with either the body portion 300 of FIG. 2A-2C or the body portion 400 of FIG. 3A-3C, or another style of body portion, as desired.

A tap sleeve can be paired with a desired tap tool to form a tapping system by selecting an appropriate tap sleeve and tap tool, and if used, selecting an appropriately adjusted stop sleeve. An appropriate tool head can also be selected, if needed. The stop sleeve, if used, is inserted into the base portion of the tap sleeve, and the tap tool is inserted into the base portion, within the stop sleeve, if present, at an appropriate depth. A set screw in the tap sleeve base is tightened to set the tap tool in place. The selected tool head, if used, is then screwed into the head portion, thereby producing the tapping system for use in fixing damaged threads in receptacles. Note that the order of this assembly operation can be changed, where desired.

FIG. 7 shows an example workpiece 200 having a pair of receptacles 210 that might be used in an example assembly process employing one of the example tap tools, when necessary.

Generally, an embodiment of the tap sleeve, such as described herein, can be used with an installed tap tool to repair damaged threads in a threaded receptacle (hole) of a workpiece. When a worker working on the workpiece determines that a threaded receptacle is damaged (such as when a fastener being installed by the worker is not properly seating in a corresponding receptacle on the workpiece during the assembly operation such as when the bolt cannot be inserted or stops short of being fully installed, or when the effort to tighten the fastener is not as expected, or some other indication of thread damage is apparent), the worker will remove the problematic fastener, which will be checked for damage.

If it is determined that the fastener is not the cause of the problem (e.g., the fastener is not damaged or otherwise not the causing the improper installation), the receptacle may be checked for damage (e.g., visually, or by attempting to “screw in” another fastener or a male test device of the proper thread pitch), or if the receptacle is otherwise assumed to be damaged, the worker can select an appropriate tap sleeve with an installed tap tool of the proper size (the “tapping system”) for repairing the receptacle. The selection of the proper tap sleeve will typically depend on the size of the desired tap tool, which depends on the size of the bolt to be used to be installed in the damaged receptacle.

The proper tapping system will typically use a tap tool of the proper diameter and thread pitch, with the tap tool installed in the tap sleeve at the proper depth, to avoid damage to the workpiece by over-insertion of the tap tool into the receptacle. As discussed above, the depth of the tap tool can be controlled by using the proper sized tap sleeve, or using a properly adjusted stop sleeve. If more than one size tap tool is needed at a given workstation, differently sized tap tools can be used with a given tap sleeve by swapping out the tap tools, or a number of tapping system pre-configured with the correct tap tools set at the proper depth can be provided at the workstation.

The repair can be manually performed by the worker operating the tapping system by gripping the tap sleeve using the handle portion, the worker “screwing” (turning) the tapping system to drive the tap tool into the receptacle by manually rotating the handle portion of the tap sleeve while concurrently inserting the tap tool of the tapping system into the receptacle, thereby “screwing” (driving) the tap into the receptacle, and then reversing the process to remove the tap tool from the receptacle, thereby effectively repairing the damaged threads in a process similar to the use of a traditional tapping procedure using a tap tool to repair damaged threads. The repaired receptacle can then be inspected and/or tested to determine if the repair was successful, in which case the worker can install a new fastener into the receptacle and complete the assembly operation.

If a tool head is provided on the tapping system for use with an external tool (e.g., wrench, hex key, screwdriver, etc.) to provide additional torque, if needed, the worker may use this external tool on the tool head to help repair the damaged threads, or to remove the tap tool from the receptacle after the repair is completed.

Alternatively, when a power tool is used to install the fasteners (e.g., bolts) into the receptacles during the assembly operation, the same power tool may be used to perform the repair, in particular where the tap tool uses a head tool that corresponds to the size of the fastener. The tap tool may be manually started in the receptacle in a manner similar to one of the manual operations described above, with the worker applying the power tool after the tap is partially inserted into the receptacle. The power tool could be a battery or pneumatically powered tool, for example. Other power tools, such as an electric screwdriver, may be used to facilitate this process, if desired.

Generally, if a fastener was removed from the damaged receptacle prior to repair, that fastener is discarded and not reused in case in has been damaged. A new fastener is installed in the repaired receptacle in the normal manner for installing such fasteners.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A tap sleeve comprising:
a base portion having a receptacle for receiving a tap tool;
a handle portion adapted for being held by a hand of a person using the tap sleeve, and having one end connecting to said base portion forming a ridge having a diameter larger than a diameter of the handle portion; and
a stop sleeve extending from said base portion receptacle, said stop sleeve being adapted to control a maximum depth of insertion of the tap tool into a receptacle being tapped using the tap sleeve with the tap tool, wherein
said tap sleeve is configured to receive any one of a plurality of differently sized tap tools.

2. The tap sleeve of claim 1, further comprising a threaded hole provided in said base portion to receive a set screw to set the tap tool securely in place.

3. The tap sleeve of claim 2, wherein said set screw also sets said stop sleeve securely in place.

4. The tap sleeve of claim 1, further comprising a head portion connected to another end of the handle portion, said head portion being configured to receive an external tool for providing a rotational torque to the tap sleeve.

5. The tap sleeve of claim 1, further comprising a head portion connected to another end of the handle portion, said head portion having a threaded receptacle that is configured to receive a removable tool head configured to receive an external tool for providing a rotational torque to the tap sleeve.

6. The tap sleeve of claim 5, wherein said base portion, said handle portion, and said head portion are comprised of a uniform material as an integral body.

7. The tap sleeve of claim 6, wherein said base portion, said handle portion, and said head portion are each substantially cylindrical in shape and are arranged co-axially.

8. The tap sleeve of claim 1, wherein said base portion and said handle portion are comprised of a steel as an integral body.

9. The tap sleeve of claim 1, wherein said stop sleeve is removable and is a selected one of a plurality of differently sized stop sleeves provided for supporting different values of said maximum depth.

10. The tap sleeve of claim 1, wherein said ridge is configured of a size to help prevent the hand of the person from slipping toward the tap tool during use.

11. The tap sleeve of claim 1, wherein said base portion and said handle portion are each cylindrical in shape and arranged co-axially as an integral body.

12. The tap sleeve of claim 1, wherein said stop sleeve is comprised of a relatively soft material selected to avoid damage to a part being tapped using the tap sleeve with the tap tool.

13. A tap sleeve comprising:
a base portion having a receptacle for receiving a tap tool and also having a threaded receptacle for receiving a set screw for securing the tap tool in the receptacle; and
a handle portion adapted for being held by a hand of a person using the tap sleeve, and having one end co-axially connecting to said base portion forming a ridge at the point of connection, said ridge having a diameter larger than a diameter of the handle portion, said ridge being configured to help prevent the hand of the person from slipping toward the tap tool, wherein
the base portion is configured to control a maximum depth of insertion of the tap tool into a receptacle being tapped using the tap sleeve with the tap tool, and wherein
said tap sleeve is configured to receive any one of a plurality of differently sized tap tools.

14. The tap sleeve of claim 13, said base portion utilizing a stop sleeve of a selectable length extending from said base portion receptacle, said stop sleeve length being adapted to control the maximum depth of insertion of the tap tool based on the selectable length.

15. The tap sleeve of claim 14, wherein said stop sleeve is comprised of a relatively soft material selected to avoid damage to a part being tapped using the tap sleeve with the tap tool.

16. The tap sleeve of claim 13, wherein said set screw also sets said stop sleeve securely in place.

17. The tap sleeve of claim 13, further comprising a head portion connected to another end of said handle portion, said head portion being configured to receive an external tool for providing a rotational torque to the tap sleeve.

18. The tap sleeve of claim 13, further comprising a head portion connected to another end of the handle portion, said head portion having a threaded receptacle that is configured to receive a removable tool head configured to receive an external tool for providing a rotational torque to the tap sleeve.

19. The tap sleeve of claim 13, wherein said base portion and said handle portion are arranged co-axially and comprised of steel formed into a cylindrical shape as an integral body.

20. A tapping system for repairing a threaded receptacle of a workpiece, said tapping system comprising:
a tap tool; and
a tap sleeve comprising:
a base portion having a receptacle for receiving a tap tool and also having a threaded receptacle for receiving a set screw for securing the tap tool in the receptacle, wherein said base portion is configured to control a maximum depth of insertion of the tap tool;
a handle portion adapted for being held by a hand of a person using the tap sleeve, and having one end co-axially connecting to said base portion forming a ridge at the point of connection, said ridge having a diameter larger than a diameter of the handle portion, said ridge being configured to help prevent the hand of the person from slipping toward the tap tool, and
a head portion having a head configured to receive a tool for providing a rotational torque to the tap sleeve;
wherein said base portion and said handle portion are arranged co-axially and comprised of a strong and hard material, and
wherein said base portion is also comprised of a relatively soft portion adapted to avoid over-insertion of the tap tool in the receptacle of the workpiece, and
wherein said tap sleeve is configured to receive said tap tools in the base portion with the tap tool being set securely in place using said set screw.
